(19) United States
(12) Patent Application Publication
(10) Pub. No.: US 2025/0136320 A1
(43) Pub. Date: May 1, 2025

(54) Coated Carton and Method of Making Same

(71) Applicant: Inno-Pak, LLC, Delaware, OH (US)

(72) Inventors: Mike Evans, Cincinnati, OH (US); Jonathan D. Sill, Delaware, OH (US)

(73) Assignee: Inno-Pak, LLC, Delaware, OH (US)

(21) Appl. No.: 18/924,231

(22) Filed: Oct. 23, 2024

Related U.S. Application Data
(60) Provisional application No. 63/546,047, filed on Oct. 27, 2023.

(51) Int. Cl. B65D 5/56; B31B 50/74; B65D 5/20

(52) U.S. Cl. CPC B65D 5/563; B31B 50/747; B65D 5/2047; B65D 5/2061

(57) ABSTRACT

A pattern-coated carton. The pattern-coated carton, may include a floor panel; side panels extending about a periphery of the floor panel, wherein the floor panel and side panels are configurable to form a container body; a closure portion, wherein the closure portion is configured to secure a top opening of the container body; and a patterned barrier coating disposed in a pattern on select portions of an outer surface of the container body.

### RELATED APPLICATIONS

This application is related and claims priority to U.S. Provisional Patent Application No. 63/546,047, filed on Oct. 27, 2023 the application of which is incorporate herein by reference in its entirety.

### TECHNICAL FIELD

The subject matter of the invention relates generally to food cartons and more particularly to pattern-coated food cartons for leak-resistant operation and methods of making same.

### SUMMARY

In one embodiment, a pattern-coated carton is provided. The pattern-coated carton, may include The pattern-coated carton, may include a floor panel; side panels extending about a periphery of the floor panel, wherein the floor panel and side panels are configurable to form a container body; a closure portion, wherein the closure portion is configured to secure a top opening of the container body; and a patterned barrier coating disposed in a pattern on select portions of an outer surface of the container body. The side panels may include a front side panel, an opposing rear side panel, a first end side panel, and an opposing second end side panel. The side panels may include a first side panel, a second end side panel, and a rear side panel, wherein the first side panel, the second end side panel, and the rear side panel may be configurable to form a triangular shaped container body. The pattern-coated carton may further include fold lines formed along where each of the side panels intersect with the floor panel, wherein the patterned barrier coating may be disposed on the outer surface of the container body along the fold lines where each of the side panels intersect with the floor panel. The patterned barrier coating may be further disposed over substantially all of the outer surface of the floor panel. The pattern-coated carton may further include webbed corner gussets extending between adjacent side panels, wherein the floor panel, side panels, and webbed corner gussets may be configurable to form the container body, and wherein the webbed corner gussets may include fold lines, each of the webbed corner gussets may include a center fold line dividing each webbed corner gusset substantially in half and fold lines formed along where the webbed corner gussets intersect with their respective adjacent side panels, and further wherein the patterned barrier coating may be further disposed on the outer surface of the container body along the fold lines of the webbed corner gussets. The patterned barrier coating may be further disposed over substantially all of the outer surface of the floor panel. The pattern-coated carton may further include a barrier coating disposed over substantially all of an inner surface of the container body. The closure portion may include, one or more foldable lid flaps extending from an uppermost edge of one or more of the side panels forming a moveable joint where the one or more foldable lid flaps and corresponding one or more side panels intersect. A first foldable lid flap and a second foldable lid flap may be adapted to engage with one another when in a folded closed position. The first foldable lid flap and the second foldable lid flap may be configured to interlock with one another via a tab formed on one of the first foldable lid flap or the second foldable lid flap and a corresponding slot formed in the other of the first foldable lid flap or the second foldable lid flap. The carton may include a single piece of material including a plurality of fold lines, and wherein the plurality of fold lines may be configured to allow the carton to be transformed from a flat pre-folded first configuration to an assembled folded second configuration. One or more of the moveable joints formed where the one or more foldable lid flaps and corresponding one or more side panels intersect may be weakened, and wherein one or more of the closure flaps may be configured to be removable from its respective side panel by tearing along a respective one of the one or more weakened moveable joints. The webbed corner gussets may be configured to be foldable and securable to an inner surface or outer surface of one of their adjacent side panels, wherein securing the webbed corner gussets to their corresponding adjacent side panels secures the container body in its assembled state.

In another embodiment, a method of making a pattern-coated carton is provided. The method may include providing a quantity of uncoated paper material; applying a barrier coating to a first side and a second side of the paper material, wherein the barrier coating is applied to substantially an entire surface of the first side of the paper material and applied as a pattern to one or more select portions of a surface of the second side of the paper material; cutting the coated paper material into an unassembled pattern-coated carton blank; and assembling the cut out blank into an assembled pattern-coated carton The pattern-coated carton may include a floor panel; side panels extending about a periphery of the floor panel, wherein the floor panel and side panels may be configurable to form a container body; a closure portion, wherein the closure portion may be configured to secure a top opening of the container body; and a barrier coating disposed in a pattern on one or more select portions of an outer surface of the container body. The paper material may include paperboard. The application of the barrier coating to the first side and second side of the paper material may be done in a serial process. The barrier coating may be applied to the first side of the paper material and then to the second side of the paper material. The pattern-coated carton may further include, fold lines formed along where each of the side panels intersect with the floor panel, and wherein the barrier coating may be applied to the surface of the second side of the paper along the fold lines formed where each of the side panels intersect with the floor panel. The barrier coating may be further applied over substantially all of the surface of a portion of the second side of the paper that makes up the floor panel portion of the pattern-coated carton. The pattern-coated carton may further include webbed corner gussets extending between adjacent side panels, wherein the floor panel, side panels, and webbed corner gussets may be configurable to form the container body, and wherein the webbed corner gussets may include fold lines, each of the webbed corner gussets may include a center fold line dividing each webbed corner gusset substantially in half and fold lines formed along where the webbed corner gussets intersect with their respective adjacent side panels, and further wherein the barrier coating may be further applied to the surface of the second side of the paper in a pattern along the fold lines of the webbed corner gussets. The barrier coating may be further applied over substantially all of the surface of a portion of the second side of the paper that makes up the floor panel portion of the pattern-coated carton. The barrier coating may be applied via a printing process to the select portions of the surface of the second side of the paper. The barrier coating may be applied to the first side of the paper material via a flood coating process.

In yet another embodiment, a method of making a pattern-coated carton is provided. The method may include providing a quantity of paper material including a barrier coating on a first side thereof; applying a patterned barrier coating to a second side of the paper material, wherein the patterned barrier coating may be applied to select portions of a surface of the second side of the paper material; cutting the coated paper material into an unassembled pattern-coated carton blank; and assembling the cut out blank into an assembled pattern-coated carton. The pattern-coated carton may include a floor panel; side panels extending about a periphery of the floor panel, wherein the floor panel and side panels may be configurable to form a container body; a closure portion, wherein the closure portion may be configured to secure a top opening of the container body; and a barrier coating disposed in a pattern on one or more select portions of an outer surface of the container body. The pattern-coated carton may further include, fold lines formed along where each of the side panels intersect with the floor panel, and wherein the barrier coating may be applied to the surface of the second side of the paper along the fold lines formed where each of the side panels intersect with the floor panel. The barrier coating may be further applied over substantially all of the surface of a portion of the second side of the paper that makes up the floor panel portion of the pattern-coated carton. The pattern-coated carton may further include webbed corner gussets extending between adjacent side panels, wherein the floor panel, side panels, and webbed corner gussets may be configurable to form the container body, and wherein the webbed corner gussets may include fold lines, each of the webbed corner gussets including a center fold line dividing each webbed corner gusset substantially in half and fold lines formed along where the webbed corner gussets intersect with their respective adjacent side panels, and further wherein the barrier coating may be further applied to the surface of the second side of the paper in a pattern along the fold lines of the webbed corner gussets. The barrier coating may be further applied over substantially all of the surface of a portion of the second side of the paper that makes up the floor panel portion of the pattern-coated carton. The barrier coating may be applied via a printing process to the select portions of the surface of the second side of the paper.

### BACKGROUND

Various products are known to be purchased by consumers that require a container for ease of transport. For example, in the food and grocery industry it is common to place food items in individual “carry-out” or “to-go” food containers. Carry-out food containers for holding food are often made of cardboard or paperboard. However, a drawback of cardboard or paperboard food containers is that they are prone to leaking. For example, cardboard or paperboard food containers tend to fail at the corners (e.g., fold lines, perforated score lines) where liquid may bleed through to the outside of the carton. Consequently, a leaking food container can be messy for the user.

### BRIEF DESCRIPTION OF THE DRAWINGS

Having thus described the subject matter of the invention in general terms, reference will now be made to the accompanying drawings, which are not necessarily drawn to scale, and wherein:

FIG. 1 illustrates a perspective view of an example pattern-coated food carton in an open state, in accordance with an example embodiment of the invention;

FIG. 2 illustrates a perspective view of the example pattern-coated food carton of FIG. 1 in a closed state, in accordance with an embodiment of the invention;

FIG. 3 illustrates an inside plan view of the example pattern-coated food carton shown in FIG. 1 and FIG. 2 in a flat pre-folded configuration, in accordance with an example embodiment of the invention;

FIG. 4 illustrates an outside plan view of the example pattern-coated food carton shown in FIG. 1 and FIG. 2 in a flat pre-folded configuration, in accordance with an example embodiment of the invention;

FIG. 5 illustrates an outside plan view of another example of the pattern-coated food carton shown in FIG. 1 and FIG. 2 in a flat pre-folded configuration, in accordance with an example embodiment of the invention;

FIGS. 6A-6D and 7A-7D illustrate additional non-limiting examples of various carton styles and configurations that may include pattern-coating, in accordance with example embodiments of the invention;

FIG. 8 illustrates a flow diagram of an example method of making the pattern-coated food cartons shown in FIG. 1 through FIG. 7D using an inline coating and/or printing process, in accordance with an embodiment of the invention; and

FIG. 9 illustrates a flow diagram of another example method of making the pattern-coated food cartons shown in FIG. 1 through FIG. 7D using an offline coating or printing process, in accordance with an embodiment of the invention.

### DETAILED DESCRIPTION

The subject matter of the invention now will be described more fully hereinafter with reference to the accompanying drawings, in which some, but not all embodiments of the subject matter of the invention are shown. Like numbers refer to like elements throughout. The subject matter of the invention may be embodied in many different forms and should not be construed as limited to the embodiments set forth herein; rather, these embodiments are provided so that this disclosure will satisfy applicable legal requirements. Indeed, many modifications and other embodiments of the subject matter of the invention set forth herein will come to mind to one skilled in the art to which the subject matter of the invention pertains having the benefit of the teachings presented in the foregoing descriptions and the associated drawings. Therefore, it is to be understood that the subject matter of the invention is not to be limited to the specific embodiments disclosed and that modifications and other embodiments are intended to be included within the scope of the appended claims.

In some embodiments, the subject matter of the invention provides pattern-coated food carton for leak-resistant operation and methods of making same.

In some embodiments, the pattern-coated food cartons and methods may provide a container body for holding any desired contents (e.g., food items) and a closure portion, which may include one or more foldable lid flaps.

In some embodiments, the food cartons and methods may provide a container body, a closure portion, which may include one or more foldable lid flaps, and may further include leak-resistant and/or leak-proof barriers/coatings at certain locations/patterns to reduce or entirely prevent leaks.

In some embodiments, the food cartons and method provide a container body, a closure portion, which may include one or more foldable lid flaps, and may further include an inside barrier coating over substantially the entire inside surface of the pattern-coated food carton and an outside barrier coating patterned on certain portions only of the outside surface of pattern-coated food carton, such as at the fold lines and/or corners (e.g., fold lines, perforated lines, score lines).

In some embodiments, the pattern-coated food cartons and methods may provide a finished good (i.e., leak-resistant food carton) that has maximum oil and grease resistance (OGR) and moisture vapor transmission rate (MVTR) barrier protection.

Further, methods of making the pattern-coated food cartons are provided.

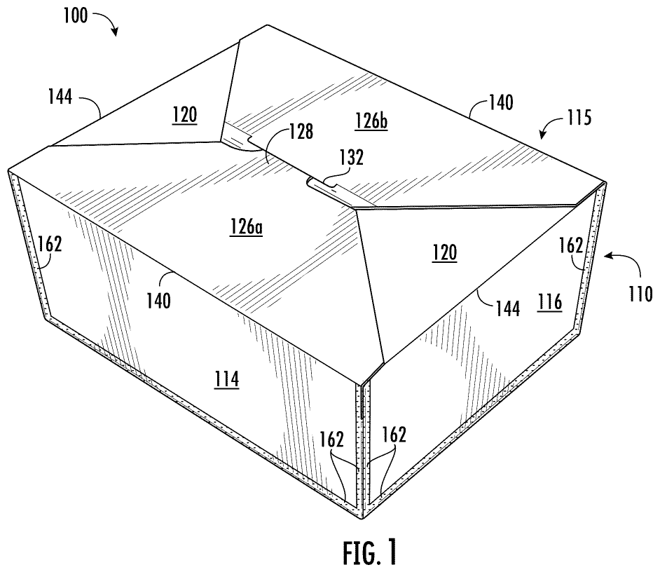

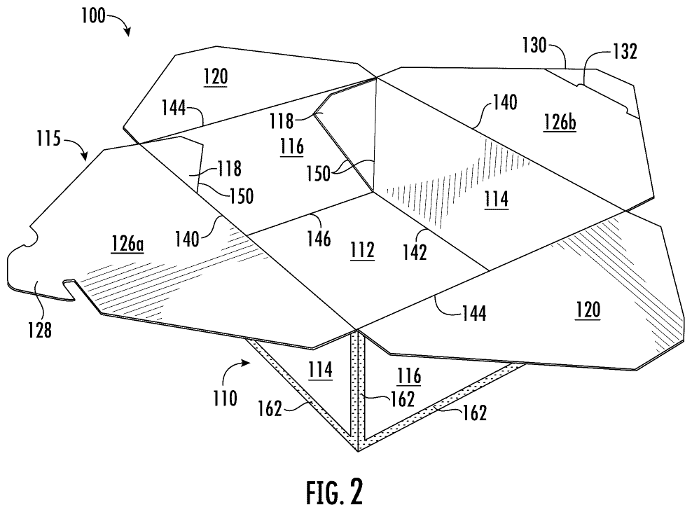

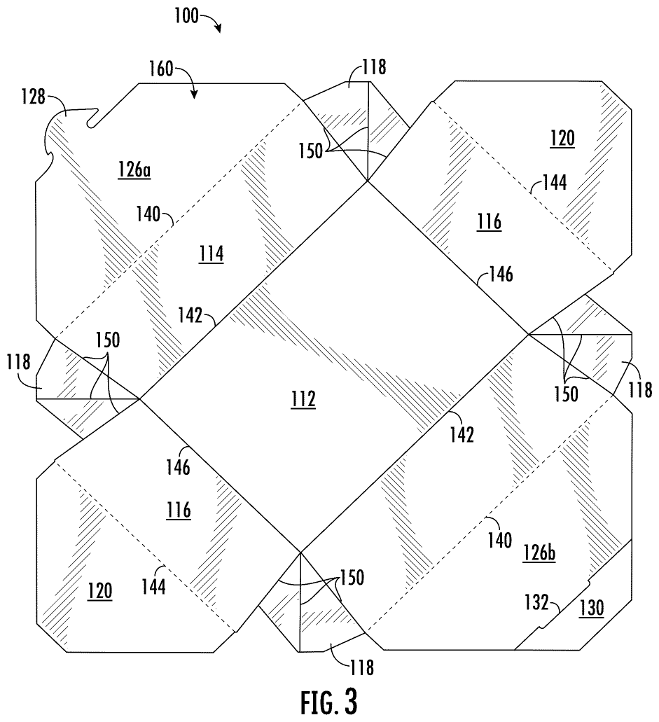

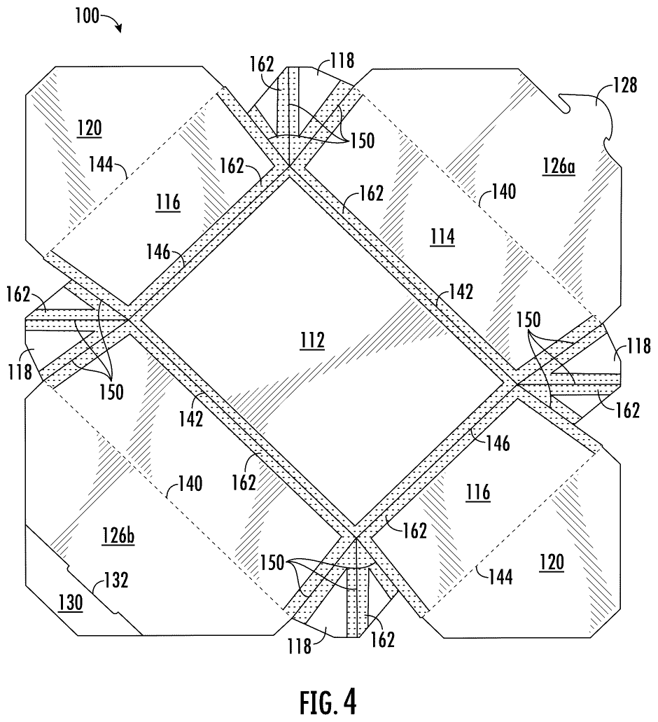

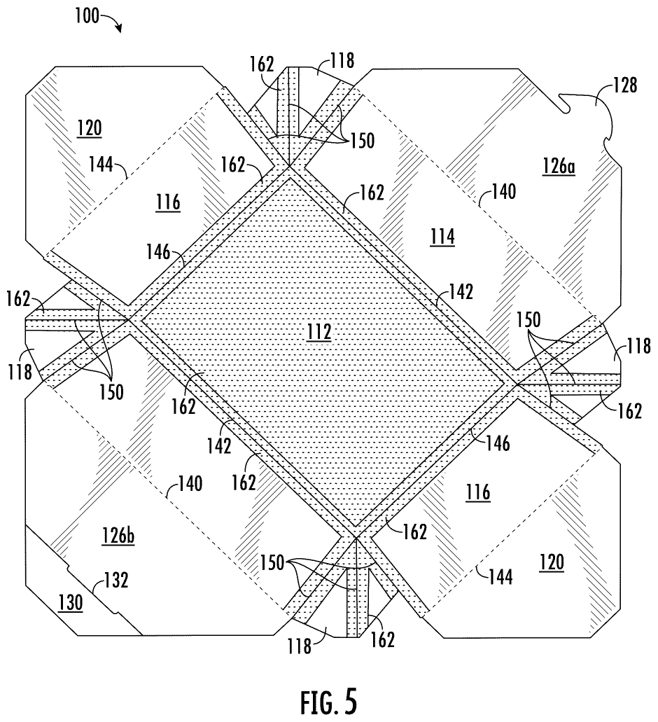

FIGS. 1, 6A, and 7A are perspective views of non-limiting examples of pattern-coated food cartons 100 in a closed state. FIGS. 2, 6B, and 7B are perspective views of non-limiting examples of pattern-coated food cartons 100 in an open state. FIG. 3 is an inside plan view of a non-limiting example of a pattern-coated food carton 100 shown in FIG. 1 and FIG. 2 in a flat pre-folded configuration. FIGS. 4, 6C, and 7C are outside plan views of non-limiting examples of pattern-coated food cartons 100 shown in FIGS. 1, 2, 6A, 6B, 7A, and 7B in a flat pre-folded configuration, all in accordance with example embodiments of the invention. FIGS. 5, 6D, and 7D are outside plan views of non-limiting examples of pattern-coated food cartons 100 shown in FIGS. 1, 2, 6A, 6B, 7A, and 7B in a flat pre-folded configuration, all in accordance with example embodiments of the invention. With respect to forming, for example, food carton products, each of the flat pre-folded configurations shown, for example, in FIGS. 3, 4, 5, 6C-D, and 7C-D may also be referred to as a “blank.”

Wherein standard food cartons, such as for example those made of paperboard, are prone to leaking at various points, such as at corners, fold lines, perforated lines, score lines, floor panel, and/or flaps; pattern-coated food carton 100 provides leak-resistant and/or leak-proof barriers at certain locations to reduce or entirely eliminate such leaks.

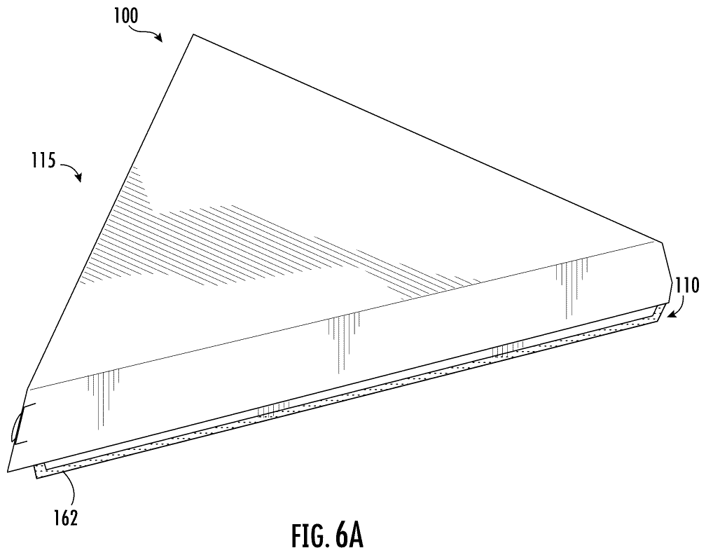

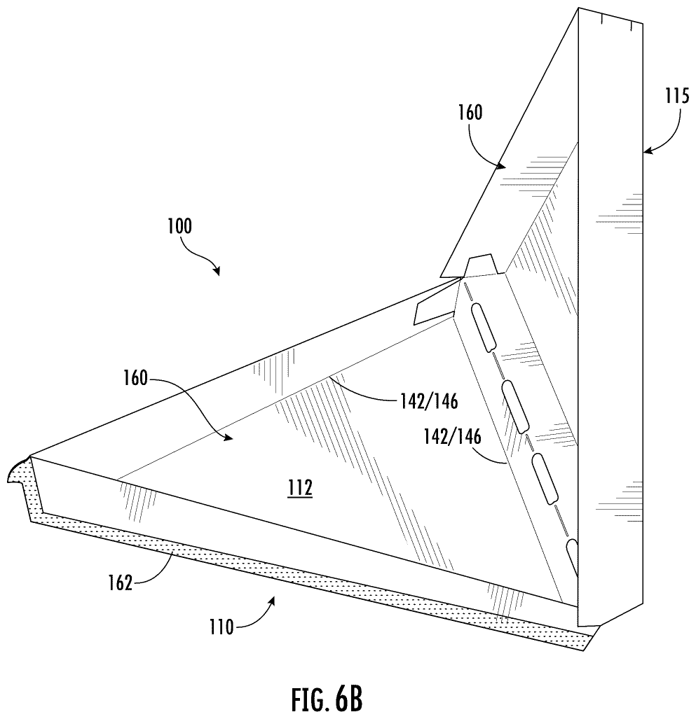

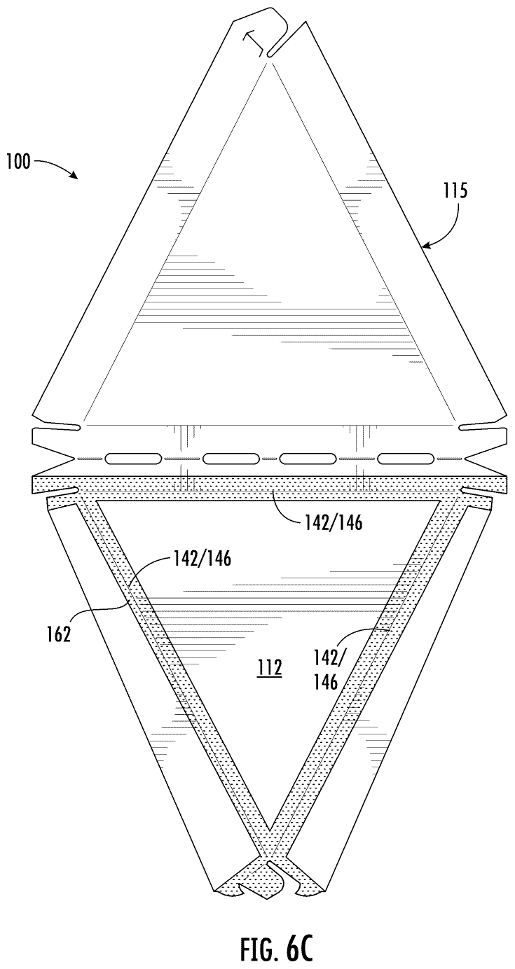

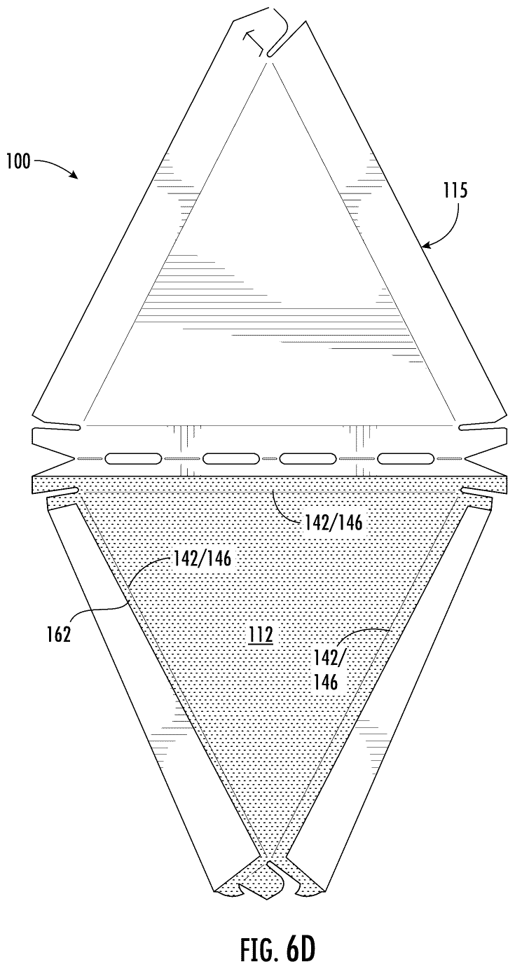

By way of example, and referring to FIG. 1 through FIG. 7D, pattern-coated food carton 100, in one example, may include a container body 110, a closure portion 115, and barrier coatings 160/162 at certain regions and/or portions of pattern-coated food carton 100. Container body 110 may include, for example, a floor panel 112, side panels (e.g., side panels 114), and one or more end side panels (e.g., end side panels 116). In one example, the ends of the side panels 114 and the end side panels 116 may be coupled via webbed corners 118. The webbed corners 118 may be, for example, a webbed corner inside glue design. The webbed corners 118 may be secured, for example, via an adhesive, thermal bonding, or any other suitable technique or mechanism. Alternatively, the webbed corners 118 may be, for example, a webbed corner outside glue design, and may be secured, for example, via an adhesive, thermal bonding, or any other suitable technique or mechanism. In other example embodiments, adjacent side panels may be coupled via glued corners (such as in FIGS. 6A-D and 7A-D), and may be secured, for example, via an adhesive, thermal bonding, or any other suitable technique or mechanism.

Closure portion 115 may include a one or more foldable flaps, such as but not limited to, one or more foldable lid end flaps 120 and/or one or more foldable lid side flaps 126.

In one non-limiting example, the top of one or more of the side panels, e.g., side panels 114 and/or end side panels 116, may be coupled to one or more of the foldable lid flaps, e.g., foldable lid side flaps 126 and/or foldable lid end flaps 120, along one or more fold lines, e.g., fold lines 140 and/or 144. The bottom of one or more of the side panels, e.g., side panels 114 and/or end side panels 116, may be coupled to floor panel 112 along the fold lines, e.g., fold lines 142 and/or 146. Further, if present, each of the webbed corners 118 may include multiple fold lines 150.

In one embodiment, closure portion 115 may be removable from container body 110. For example, one or more of the foldable lid flaps, e.g., foldable lid end flaps 120 and/or foldable lid side flaps 126, may be removable from the top edge of the container body 110, e.g., from side panels 116 and/or end side panels 114, along, for example, their respective fold lines, e.g., fold lines 144 and/or fold lines 140. In one example, the fold lines, e.g., fold lines 144 and/or fold lines 140, may be weakened to facilitate removal of one or more of the foldable lid flaps, e.g., foldable lid end flaps 120 and/or foldable lid side flaps 126. The fold lines, e.g., fold lines 144 and/or fold lines 140, may be perforated, scored, laser cut, embossed, or weakened in any other suitable manner to facilitate the removal of the one or more foldable lid flaps from the top edge of the side panels, for example by a user pulling on the foldable lid flaps.

Pattern-coated food carton 100 may be formed of any lightweight, rigid or semi-rigid material that is suitable for holding and/or transporting, for example, a quantity of cold and/or hot food and that is also suitable for disposing of after use. For example, pattern-coated food carton 100 may be formed of paperboard, corrugated cardboard, micro-fluted corrugated material, paper, solid unbleached sulphate (SUS) paperboard, solid bleached sulphate (SBS) paperboard, post-consumer paperboard (i.e., recycled materials), biodegradable materials (e.g., sugarcane and paper), polystyrene foam (e.g., Styrofoam), plastic, molded fiber, and/or the like.

With respect to providing leak-resistant and/or leak-proof barriers 160/162, pattern-coated food carton 100 may include barrier coatings at certain regions and/or portions of container body 110. The barrier coatings provide leak-resistant and/or leak-proof barriers for minimizing or entirely preventing leaks. In one example, an inside barrier coating 160 may be provided over all, or substantially all, of the entire inside surface area of pattern-coated food carton 100. Further, an outside barrier coating 162 may be provided on the outside of container body 110 along, for example, along fold lines 142, fold lines 146, one or more of fold lines 150 of webbed corners 118, and/or other regions, such as corner regions of the container body 110, as shown for example in FIGS. 4, 6C, and 7C. That is, while the inside of pattern-coated food carton 100 may be coated fully with inside barrier coating 160, smaller portions only of the outside of pattern-coated food carton 100 may be coated with outside barrier coating 162. Barrier coating 162 may be in the range of about ½ inch to about 1 inch in width evenly split along any, or all, of fold lines 142, fold lines 146, one or more of fold lines 150, and/or corner intersections. However, barrier coating 162 may be of a width less than or greater than in the range of about ½ inch to about 1 inch wide, and may be any suitable width as may be necessary for the size and/or intended use of the pattern-coated food carton 100.

In accordance with another example embodiment of the invention, pattern-coated food carton 100 may additionally (or alternatively) include outside barrier coating 162 provided over the entire outside surface area of floor panel 112, as shown for example in FIGS. 5, 6D, and 7D.

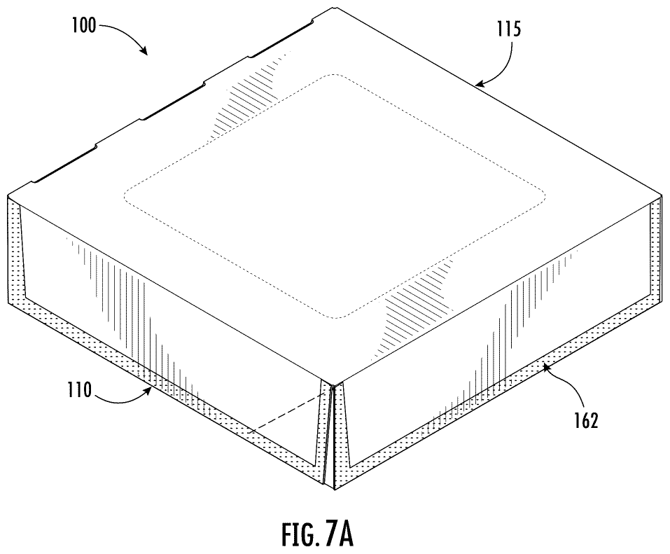

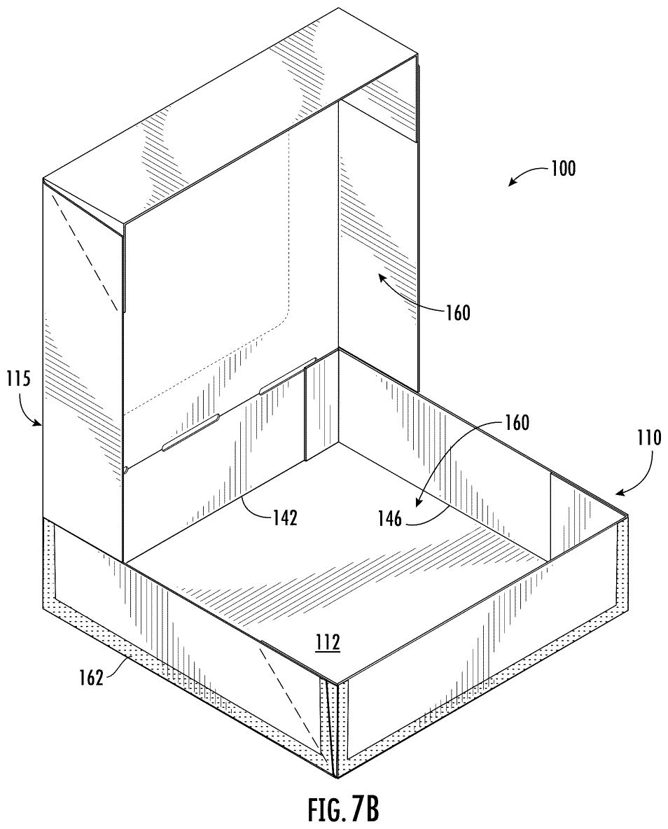

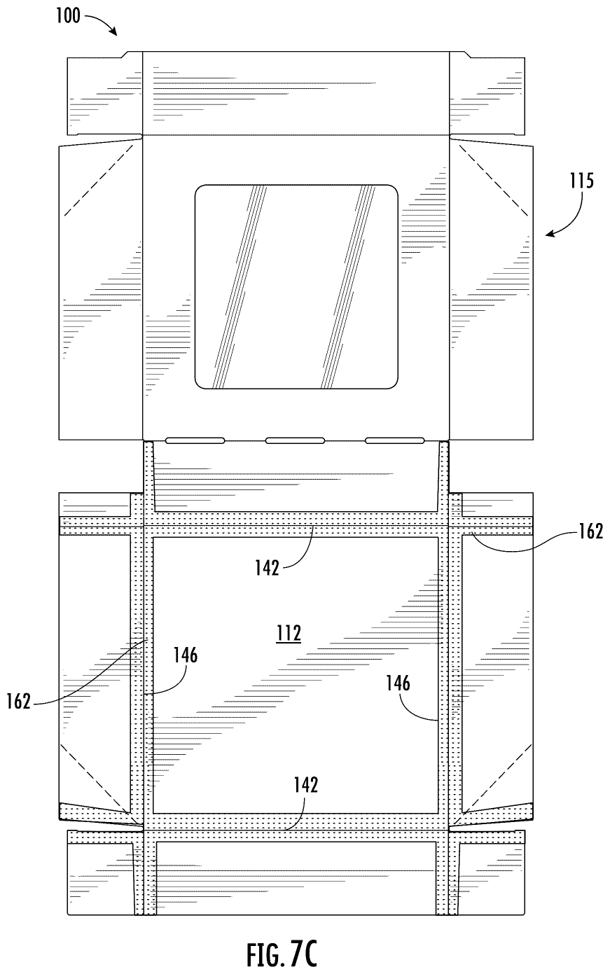

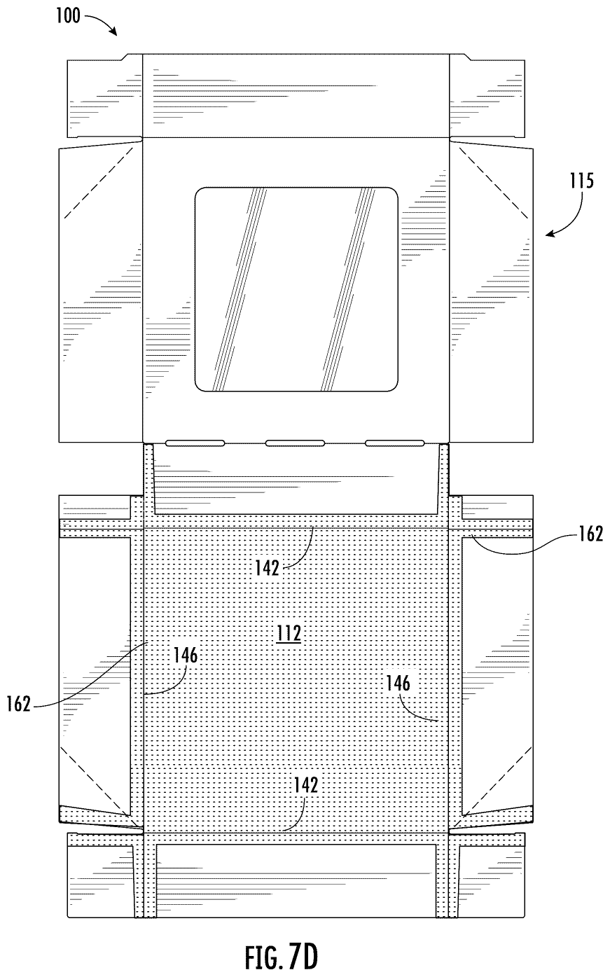

FIGS. 6A-6D, and FIGS. 7A-7D illustrate various views of additional, non-limiting, examples of other food carton styles and configurations of pattern-coated food carton 100. Pattern-coated food carton 100 may be of any form, shape, style, and/or configuration suitable for holding/containing food, and is not limited to the example cartons shown in the figures herein.

In pattern-coated food carton 100, barrier coatings 160 and 162 may be, for example, aqueous based coatings that may consist of primarily water, barrier elements, binders, and/or other additives. The barrier elements may be synthetic or bio-based elements. Examples of barrier elements may include, but are not limited to, calcium carbonate, talc, and/or other like minerals. Examples of binders may include, but are not limited to, acrylics, latex, and/or bio-based binders. Examples of other additives may include, but are not limited to, defoamers to keep the coating from foaming during the application process and/or other process aids for application.

The barrier coatings may be formulated into a chemical that may be applied via a flood coating on one side (e.g., the inside of container body 110) and a pattern print on the opposite side (e.g., the outside of container body 110). Barrier coatings 160 and 162 may provide OGR as well as MVTR barrier protection. One benefit of barrier coatings 160 and 162 is to replace the commonly used polyethylene (PE) and polylactic acid (PLA) extrusion coatings with a more sustainable solution.

The presence of inside barrier coating 160 and outside barrier coating 162 at certain portions of container body 110 may reduce or entirely prevent liquid from bleeding out at certain leak prove areas (e.g., fold lines, perforated lines, score lines). Again, outside barrier coating 162 may be applied on the outside of pattern-coated food carton 100 (via printing plates) in a pattern lay down-applying the coating only to the scored/perforated/fold area(s) of the carton. Accordingly, cost savings may occur by not having to apply outside barrier coating 162 to the entire exterior surface while still reducing or entirely preventing leaking.

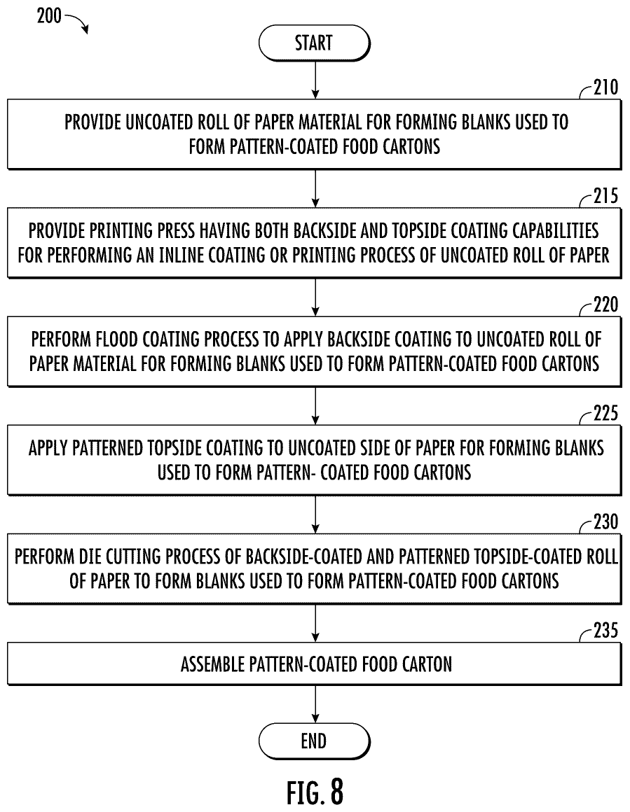

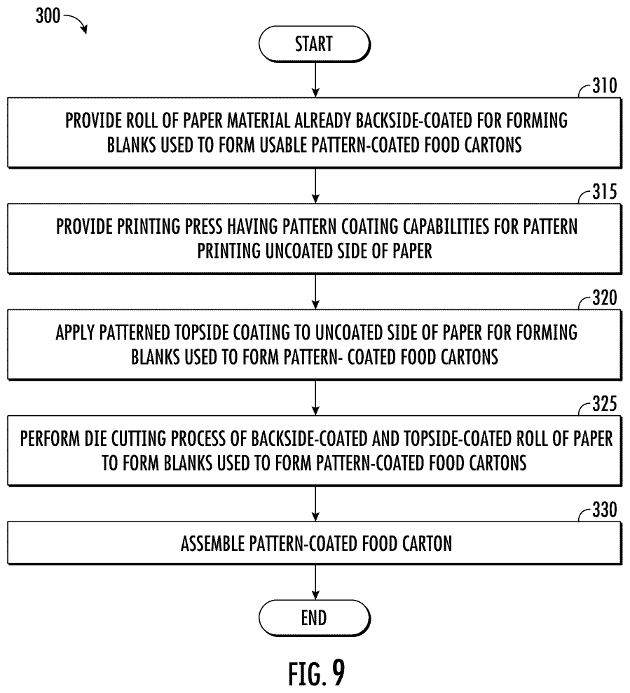

In conventional food cartons, such as for example those made of paperboard, coatings are typically applied in two coats, a base coating and a top coating. In one example, a method of making pattern-coated food carton 100 may be provided that may include applying a single coat only. Thereby simplifying and lowering the cost of the coating process. However, in another example, a method of making pattern-coated food carton 100 may be provided that may include applying two coats, such as for example, a base coating and a top coating. In such an example, the backside coating may serve as a sealant layer on the paperboard and the topside coating may enhance and add barrier properties for the coating. More details of methods of applying inside barrier coating 160 and outside barrier coating 162 to form pattern-coated food carton 100 are shown and described below in FIG. 8 and FIG. 9.

Referring now to FIG. 8 is a flow diagram of an example of a method 200 of making pattern-coated food carton 100 such as that shown, for example, in FIG. 1-FIG. 7D using an inline coating and/or printing process, in accordance with an example embodiment of the invention. In method 200, the term “backside” corresponds to the “inside” of the finished pattern-coated food carton 100. Further, the term “topside” corresponds to the “outside” of the finished pattern-coated food carton 100. Method 200 may include, but is not limited to, the following steps, which may vary in order.

At a step 210, an uncoated roll of paper may be provided for forming the blanks used to form usable pattern-coated food cartons. For example, an uncoated roll of paperboard, corrugated cardboard, micro-fluted corrugated material, paper, SUS paperboard, SBS paperboard, post-consumer paperboard (i.e., recycled materials), biodegradable materials (e.g., sugarcane and paper), polystyrene foam (e.g., Styrofoam), plastic, molded fiber, or the like may be provided for forming pattern-coated food cartons 100. That is, this uncoated roll of paper may be used for forming blanks as shown, for example, in FIG. 3, FIG. 4, FIG. 5, FIG. 6C, FIG. 6D, FIG. 7C, or FIG. 7D.

At a step 215, a printing press having both backside and topside coating capabilities may be provided for performing an inline coating and/or printing process of the uncoated roll of paper for forming the blanks used to form the usable pattern-coated food cartons. For example, depending on the printing press and drying needs, the backside coating may happen in the first station(s) or the last station(s) of the printing press. With the inline coating and/or printing process, the backside and topside coatings may be applied on the paper in one pass through the printing press.

At a step 220, a flood coating process may be performed to apply the backside coating to the uncoated roll of paper for forming the blanks used to form the usable pattern-coated food cartons. For example, one side of the uncoated roll of paper may receive the flood coating of inside barrier coating 160 as shown. Examples of flood coaters may be a rod coater, a blade coater, a size press, and/or any other suitable mechanism and/or technique. Again, the flood-coated backside of the roll of paper ultimately corresponds to the inside of the finished pattern-coated food cartons 100.

At a step 225, a patterned topside coating may be applied to the uncoated side of the paper for forming the blanks used to form the usable pattern-coated food cartons. For example, a flexographic printing press, lithographic offset printing press, rotogravure printing press, or other suitable mechanism and/or technique may be used to apply the patterned topside coating to the uncoated side of the paper for forming the blanks used to form the usable pattern-coated food cartons 100. In method 200, the patterned topside coating may be outside barrier coating 162 printed on the outside surface of pattern-coated food carton 100, as shown, for example, in FIG. 4, FIG. 5, FIG. 6C, FIG. 6D, FIG. 7C, and/or FIG. 7D.

Again, the patterned topside coating of the roll of paper ultimately corresponds to the outside of the finished pattern-coated food cartons 100. For example, the patterned topside coating (e.g., outside barrier coating 162) may be applied on what will become the bottom edges (e.g., fold lines 142 and/or fold lines 146 of floor panel 112), vertical edges (e.g., fold lines 150 of webbed corners 118 and/or corner intersections), and/or floor panel 112 of pattern-coated food cartons 100.

At a step 230, a die cutting process is performed of the backside-coated and topside-coated roll of paper to form the blanks used to form the usable pattern-coated food cartons 100. Examples of blanks for forming a pattern-coated food carton 100 are shown, for example, in FIG. 3, FIG. 4, FIG. 5 FIG. 6C, FIG. 6D, FIG. 7C, and FIG. 7D.

At a step 235, a leak-resistant pattern-coated food carton is assembled by, for example, folding and/or gluing the now backside-coated and topside-coated blank. For example, the leak-resistant pattern-coated food carton 100 may be assembled by, for example, folding and/or gluing the now backside-coated and topside-coated blank, as shown, for example, in FIG. 1, FIG. 2, FIG. 6A, FIG. 6B, FIG. 7A, and FIG. 7B.

In method 200, inside barrier coating 160 applied in step 220 provides the primary barrier layer of the leak-resistant pattern-coated food carton 100. By contrast, the pattern print of the outside barrier coating 162 at step 225 (see for example FIG. 4, FIG. 5, FIG. 6C, FIG. 6D, FIG. 7C, or FIG. 7D) provides additional barrier protection on the scores, perforated, fold lines, and/or floor panel of the leak-resistant pattern-coated food carton 100 that may have a tendency to leak and/or crack or cause defects in the barrier coating (e.g., inside barrier coating 160).

In other embodiments of method 200, steps 220 and 225 may be reversed. That is, the outside barrier coating 162 may be pattern printed on what will become the outside surface of pattern-coated food cartons 100 first, followed by what will become the inside surface receiving the flood coating of inside barrier coating 160.

Referring now to FIG. 9 is a flow diagram of another example of a method 300 of making pattern-coated food carton 100 that is shown, for example, in FIG. 1-FIG. 5, FIGS. 6A-6D, and 7A-7D using an offline coating or printing process, in accordance with an embodiment of the invention. In method 300, the term “backside” corresponds to the “inside” of the finished pattern-coated food carton 100. Further, the term “topside” corresponds to the “outside” of the finished pattern-coated food carton 100. Method 300 may include, but is not limited to, the following steps.

At a step 310, a roll of paper is provided that already has the backside coating for forming blanks used to form usable pattern-coated food cartons. For example, a roll of paperboard, corrugated cardboard, micro-fluted corrugated material, paper, SUS paperboard, SBS paperboard, post-consumer paperboard (i.e., recycled materials), biodegradable materials (e.g., sugarcane and paper), polystyrene foam (e.g., Styrofoam), plastic, molded fiber, or the like that already has the backside coating may be provided for forming pattern-coated food cartons 100. That is, this backside-coated roll of paper may be used for forming blanks as shown, for example, in FIG. 3, FIG. 4, FIG. 5, FIG. 6C, FIG. 6D, FIG. 7C, or FIG. 7D. Further, this backside-coated roll of paper may be formed via a flood coating process of one side to form inside barrier coating 160. For example, the backside of the uncoated roll of paper may receive the flood coating of inside barrier coating 160. Examples of flood coaters may be a rod coater, a blade coater, a size press, and/or other suitable mechanism and/or technique.

At a step 315, an offline printing press having pattern coating capabilities for pattern printing the uncoated side of paper is provided. For example, a flexographic printing press, lithographic offset printing press, rotogravure printing press, and/or other suitable mechanism and/or technique may be provided.

At a step 320, a patterned topside coating may be applied to the uncoated side of the paper for forming the blanks used to form the usable pattern-coated food cartons 100. In method 300, the patterned topside coating may be outside barrier coating 162 printed on the outside surface of pattern-coated food carton 100, as shown, for example, in FIG. 4, FIG. 5, FIG. 6C, FIG. 6D, FIG. 7C, or FIG. 7D. Again, the patterned topside coating of the roll of paper ultimately corresponds to the outside of the finished pattern-coated food cartons 100. For example, the patterned topside coating (e.g., outside barrier coating 162) may be applied on what will become the bottom edges (e.g., fold lines 142 and/or fold lines 146 of floor panel 112) vertical edges (e.g., fold lines 150 of webbed corners 118 and/or corner intersections), and/or floor panel 112 of pattern-coated food cartons 100.

At a step 325, a die cutting process is performed of the backside-coated and topside-coated roll of paper to form the blanks used to form the usable pattern-coated food cartons 100. Examples of blanks for forming a pattern-coated food carton 100 are shown, for example, in FIG. 3, FIG. 4, FIG. 5, FIG. 6C, FIG. 6D, FIG. 7C, and FIG. 7D.

At a step 330, a leak-resistant pattern-coated food carton is assembled by, for example, folding and/or gluing the now backside-coated and topside-coated blank. For example, the leak-resistant pattern-coated food carton 100 may be assembled by, for example, folding and/or gluing the now backside-coated and topside-coated blank, as shown, for example, in FIG. 1, FIG. 2, FIG. 6A, FIG. 6B, FIG. 7A, and FIG. 7B.

In method 300, inside barrier coating 160 applied in step 210 (see, for example, FIG. 3) provides the primary barrier layer of the leak-resistant pattern-coated food carton 100. By contrast, the pattern print of the outside barrier coating 162 at step 320 (see, for example, FIG. 4, FIG. 5 FIG. 6C, FIG. 6D, FIG. 7C, or FIG. 7D) provides additional barrier protection on the scores, perforated, fold lines, and/or floor panel of the leak-resistant pattern-coated food carton 100 that may have a tendency to leak and/or crack or cause defects in the barrier coating (e.g., inside barrier coating 160).

In method 300, inside barrier coating 160 on the roll of paper provided in step 310 (see FIG. 3) provides the primary barrier layer of the leak-resistant pattern-coated food carton 100. By contrast, the pattern print of the outside barrier coating 162 at step 320 (see, for example, FIG. 4, FIG. 5 FIG. 6C, FIG. 6D, FIG. 7C, or FIG. 7D) provides additional barrier protection on the scores, folds, and corners of the leak-resistant pattern-coated food carton 100.

In summary and referring now again to FIGS. 1-7D, pattern-coated food cartons 100 and method 200, 300 include container body 110 for holding any desired contents (e.g., food items) and a closure portion 115.

Additionally, pattern-coated food carton 100 provides leak-resistant and/or leak-proof barriers at certain locations to reduce or entirely prevent leaks. For example, inside barrier coating 160 may be provided over the entire inside surface of pattern-coated food carton 100. Further, outside barrier coating 162 may be patterned on certain portions only of the outside surface of pattern-coated food carton 100. For example, outside barrier coating 162 may be patterned on the portions of pattern-coated food carton 100 that may have risk of leaking, such as, for example, fold lines, perforated lines, score lines, corners, and bottom panel. The presence of inside barrier coating 160 and outside barrier coating 162 in leak-resistant pattern-coated food carton 100 provides a finished good that has enhanced/maximum OGR and MVTR barrier protection.

Following long-standing patent law convention, the terms “a,” “an,” and “the” refer to “one or more” when used in this application, including the claims. Thus, for example, reference to “a subject” includes a plurality of subjects, unless the context clearly is to the contrary (e.g., a plurality of subjects), and so forth.

The terms “comprise,” “comprises,” “comprising,” “include,” “includes,” and “including,” are intended to be non-limiting, such that recitation of items in a list is not to the exclusion of other like items that may be substituted or added to the listed items.

Terms like “preferably,” “commonly,” and “typically” are not utilized herein to limit the scope of the claimed embodiments or to imply that certain features are critical or essential to the structure or function of the claimed embodiments. These terms are intended to highlight alternative or additional features that may or may not be utilized in a particular embodiment of the present invention.

The term “substantially” is utilized herein to represent the inherent degree of uncertainty that may be attributed to any quantitative comparison, value, measurement, or other representation and to represent the degree by which a quantitative representation may vary from a stated reference without resulting in a change in the basic function of the subject matter at issue.

Various modifications and variations of the disclosed methods, compositions and uses of the invention will be apparent to the skilled person without departing from the scope and spirit of the invention. Although the subject matter has been disclosed in connection with specific preferred aspects or embodiments, it should be understood that the subject matter as claimed should not be unduly limited to such specific aspects or embodiments.

For the purposes of this specification and appended claims, unless otherwise indicated, all numbers expressing amounts, sizes, dimensions, proportions, shapes, formulations, parameters, percentages, quantities, characteristics, and other numerical values used in the specification and claims, are to be understood as being modified in all instances by the term “about” even though the term “about” may not expressly appear with the value, amount or range. Accordingly, unless indicated to the contrary, the numerical parameters set forth in the following specification and attached claims are not and need not be exact, but may be approximate and/or larger or smaller as desired, reflecting tolerances, conversion factors, rounding off, measurement error and the like, and other factors known to those of skill in the art depending on the desired properties sought to be obtained by the presently disclosed subject matter. For example, the term “about,” when referring to a value can be meant to encompass variations of, in some embodiments ±100%, in some embodiments ±50%, in some embodiments ±20%, in some embodiments ±10%, in some embodiments ±5%, in some embodiments ±1%, in some embodiments ±0.5%, and in some embodiments ±0.1% from the specified amount, as such variations are appropriate to perform the disclosed methods or employ the disclosed compositions.

Further, the term “about” when used in connection with one or more numbers or numerical ranges, should be understood to refer to all such numbers, including all numbers in a range and modifies that range by extending the boundaries above and below the numerical values set forth. The recitation of numerical ranges by endpoints includes all numbers, e.g., whole integers, including fractions thereof, subsumed within that range (for example, the recitation of 1 to 5 includes 1, 2, 3, 4, and 5, as well as fractions thereof, e.g., 1.5, 2.25, 3.75, 4.1, and the like) and any range within that range.

Although the foregoing subject matter has been described in some detail by way of illustration and example for purposes of clarity of understanding, it will be understood by those skilled in the art that certain changes and modifications can be practiced within the scope of the appended claims.

That which is claimed:

1. A pattern-coated carton, comprising:
a. a floor panel;
b. side panels extending about a periphery of the floor panel, wherein the floor panel and side panels are configurable to form a container body;
c. a closure portion, wherein the closure portion is configured to secure a top opening of the container body; and
d. a patterned barrier coating disposed in a pattern on one or more select portions of an outer surface of the container body.

2. The pattern-coated carton of claim 1, wherein the side panels comprise a front side panel, an opposing rear side panel, a first end side panel, and an opposing second end side panel.

3. The pattern-coated carton of claim 1, wherein the side panels comprise a first side panel, a second side panel, and a rear side panel, wherein the first side panel, the second end side panel, and the rear side panel are configurable to form a triangular shaped container body.

4. The pattern-coated carton of claim 1, further comprising fold lines formed along where each of the side panels intersect with the floor panel, wherein the patterned barrier coating is disposed on the outer surface of the container body along the fold lines where each of the side panels intersect with the floor panel.

5. The pattern-coated carton of claim 4, wherein the patterned barrier coating is further disposed over substantially all of the outer surface of the floor panel.

6. The pattern-coated carton of claim 4, further comprising webbed corner gussets extending between adjacent side panels, wherein the floor panel, side panels, and webbed corner gussets are configurable to form the container body, and wherein the webbed corner gussets comprise fold lines, each of the webbed corner gussets including a center fold line dividing each webbed corner gusset substantially in half and fold lines formed along where the webbed corner gussets intersect with their respective adjacent side panels, and further wherein the patterned barrier coating is further disposed on the outer surface of the container body along the fold lines of the webbed corner gussets.

7. The pattern-coated carton of claim 6, wherein the patterned barrier coating is further disposed over substantially all of the outer surface of the floor panel.

8. The pattern-coated carton of claim 1, further comprising a barrier coating disposed over substantially all of an inner surface of the container body.

9. The pattern-coated carton of claim 1, wherein the closure portion comprises, one or more foldable lid flaps extending from an uppermost edge of one or more of the side panels forming a moveable joint where the one or more foldable lid flaps and corresponding one or more side panels intersect.

10. The pattern-coated carton of claim 9, wherein a first foldable lid flap and a second foldable lid flap are adapted to engage with one another when in a folded closed position.

11. The pattern-coated carton of claim 10, wherein the first foldable lid flap and the second foldable lid flap are configured to interlock with one another via a tab formed on one of the first foldable lid flap or the second foldable lid flap and a corresponding slot formed in the other of the first foldable lid flap or the second foldable lid flap.

12. The pattern-coated carton of claim 1, wherein the carton comprises a single piece of material comprising a plurality of fold lines, and wherein the plurality of fold lines are configured to allow the carton to be transformed from a flat pre-folded first configuration to an assembled folded second configuration.

13. The pattern-coated carton of claim 9, wherein one or more of the moveable joints formed where the one or more foldable lid flaps and corresponding one or more side panels intersect are weakened, and wherein one or more of the closure flaps are configured to be removable from its respective side panel by tearing along a respective one of the one or more weakened moveable joints.

14. The pattern-coated carton of claim 6, wherein the webbed corner gussets are configured to be foldable and securable to an inner surface or outer surface of one of their adjacent side panels, wherein securing the webbed corner gussets to their corresponding adjacent side panels secures the container body in its assembled state.

15. A method of making a pattern-coated carton, the method comprising:
a. providing a quantity of uncoated paper material;
b. applying barrier coating to a first side and a second side of the paper material, wherein the barrier coating is applied to substantially an entire surface of the first side of the paper material and applied as a pattern to one or more select portions of a surface of the second side of the paper material;
c. cutting the coated paper material into an unassembled pattern-coated carton blank; and
d. assembling the cut out blank into an assembled pattern-coated carton, comprising:
i. a floor panel;
ii. side panels extending about a periphery of the floor panel, wherein the floor panel and side panels are configurable to form a container body;
iii. a closure portion, wherein the closure portion is configured to secure a top opening of the container body; and
iv. a barrier coating disposed in a pattern on one or more select portions of an outer surface of the container body.

16. The method of claim 15, wherein the paper material comprises paperboard.

17. The method of claim 15, wherein application of the barrier coating to the first side and second side of the paper material is done in a serial process.

18. The method of claim 15, wherein the barrier coating is applied to the first side of the paper material and then to the second side of the paper material.

19. The method of claim 15, wherein the pattern-coated carton further comprises, fold lines formed along where each of the side panels intersect with the floor panel, and wherein the barrier coating is applied to the surface of the second side of the paper along the fold lines formed where each of the side panels intersect with the floor panel.

20. The method of claim 19, wherein the barrier coating is further applied over substantially all of the surface of a portion of the second side of the paper that comprises the floor panel portion of the pattern-coated carton.

21. The method of claim 19, further comprising webbed corner gussets extending between adjacent side panels, wherein the floor panel, side panels, and webbed corner gussets are configurable to form the container body, and wherein the webbed corner gussets comprise fold lines, each of the webbed corner gussets including a center fold line dividing each webbed corner gusset substantially in half and fold lines formed along where the webbed corner gussets intersect with their respective adjacent side panels, and further wherein the barrier coating is further applied to the surface of the second side of the paper in a pattern along the fold lines of the webbed corner gussets.

22. The method of claim 21, wherein the barrier coating is further applied over substantially all of the surface of a portion of the second side of the paper that comprises the floor panel portion of the pattern-coated carton.

23. The method of claim 15, wherein the barrier coating is applied via a printing process to the select portions of the surface of the second side of the paper.

24. The method of claim 15, wherein the barrier coating is applied to the first side of the paper material via a flood coating process.

25. A method of making a pattern-coated carton, the method comprising:
a. providing a quantity of paper material comprising a barrier coating on a first side thereof;
b. applying a patterned barrier coating to a second side of the paper material, wherein the patterned barrier coating is applied to select portions of a surface of the second side of the paper material;
c. cutting the coated paper material into an unassembled pattern-coated carton blank; and
d. assembling the cut out blank into an assembled pattern-coated carton, comprising:
i. a floor panel;
ii. side panels extending about a periphery of the floor panel, wherein the floor panel and side panels are configurable to form a container body;
iii. a closure portion, wherein the closure portion is configured to secure a top opening of the container body; and
iv. a barrier coating disposed in a pattern on one or more select portions of an outer surface of the container body.

26. The method of claim 25, wherein the pattern-coated carton further comprises, fold lines formed along where each of the side panels intersect with the floor panel, and wherein the barrier coating is applied to the surface of the second side of the paper along the fold lines formed where each of the side panels intersect with the floor panel.

27. The method of claim 26, wherein the barrier coating is further applied over substantially all of the surface of a portion of the second side of the paper that comprises the floor panel portion of the pattern-coated carton.

28. The method of claim 26, further comprising webbed corner gussets extending between adjacent side panels, wherein the floor panel, side panels, and webbed corner gussets are configurable to form the container body, and wherein the webbed corner gussets comprise fold lines, each of the webbed corner gussets including a center fold line dividing each webbed corner gusset substantially in half and fold lines formed along where the webbed corner gussets intersect with their respective adjacent side panels, and further wherein the barrier coating is further applied to the surface of the second side of the paper in a pattern along the fold lines of the webbed corner gussets.

29. The method of claim 28, wherein the barrier coating is further applied over substantially all of the surface of a portion of the second side of the paper that comprises the floor panel portion of the pattern-coated carton.

30. The method of claim 25, wherein the barrier coating is applied via a printing process to the select portions of the surface of the second side of the paper.
